(19) United States
(12) Patent Application Publication
(10) Pub. No.: US 2022/0390181 A1
(43) Pub. Date: Dec. 8, 2022

(54) HEAT EXCHANGER

(71) Applicant: NGK Insulators, Ltd., Nagoya-City (JP)

(72) Inventors: Tatsuya AKAHANI, Nagoya-City (JP); Tatsuo KAWAGUCHI, Mizhuho-City (JP); Makoto YOSHIHARA, Iwakura-City (JP)

(73) Assignee: NGK Insulators, Ltd., Nagoya-City (JP)

(21) Appl. No.: 17/820,009

(22) Filed: Aug. 16, 2022

Related U.S. Application Data
(63) Continuation of application No. PCT/JP2020/035863, filed on Sep. 23, 2020.

(30) Foreign Application Priority Data
Feb. 25, 2020 (JP) 2020-029800

(51) Int. Cl. F28D 7/16; F28F 27/00

(52) U.S. Cl. CPC F28D 7/16; F28F 27/00

(57) ABSTRACT

A heat exchanger includes a hollow pillar shaped honeycomb structure, a first outer cylindrical member, an inner cylindrical member, an upstream cylindrical member, a cylindrical connecting member, and a downstream cylindrical member. The heat exchanger further includes a valve mechanism having an on-off valve located on a downstream end portion side of the inner cylindrical member. The valve mechanism is rotatably supported by a bearing arranged on a radially outer side of the downstream cylindrical member, and the on-off valve is fixed to a shaft arranged so as to penetrate the downstream cylindrical member and the inner cylindrical member.

### FIELD OF THE INVENTION

The present invention relates to a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce friction losses, in order to prevent deterioration of fuel economy at the time when an engine is cold, such as when the engine is started. Further, a system is expected that heats an exhaust gas purifying catalyst in order to activate the catalyst at an early stage.

As one of such systems, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

Patent Literature 1 proposes a heat exchanger including: a heat collecting portion formed as a honeycomb structure having a plurality of cells through which a first fluid (for example, an exhaust gas) can flow; and a casing arranged to cover an outer peripheral surface of the heat collecting portion, through which a second fluid (for example, cooling water) can flow between the heat collecting portion and the casing.

However, the heat exchanger of Patent Literature 1 has a structure in which waste heat from the first fluid to the second fluid is constantly collected. Therefore, even if there is no need to collect the waste heat (even if the heat exchange is not needed), the waste heat might be collected. Therefore, the heat exchanger has been required to increase a capacity of a radiator for discharging the collected waste heat even if there has been no need to collect the waste heat.

On the other hand, Patent Literature 2 discloses a heat exchanger, including: a hollow pillar shaped honeycomb structure; a covering member covering an outer peripheral wall of the hollow pillar shaped honeycomb structure; an inner cylinder which is arranged in a hollow region of the hollow pillar shaped honeycomb structure and which has through holes for introducing a fluid into cells of the hollow pillar shaped honeycomb structure; a frame forming a flow path for a second fluid between the frame and the covering member; and an on-off valve for shutting off the flow of a first fluid inside the inner cylinder during heat exchange between the first fluid and the second fluid. The heat exchanger can perform switching between promotion and suppression of heat recovery (heat exchange) by opening and closing the on-off valve.

### PRIOR ART

### Patent Literatures

[Patent Literature 1] Japanese Patent Application Publication No. 2012-037165 A
[Patent Literature 2] WO 2019/135312 A1

### SUMMARY OF THE INVENTION

The present invention relates to a heat exchanger, comprising:

a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;

a first outer cylindrical member fitted to a surface of the outer peripheral wall of the pillar shaped honeycomb structure;

an inner cylindrical member fitted to a surface of the inner peripheral wall of the pillar shaped honeycomb structure;

an upstream cylindrical member having a portion arranged on a radially inner side of the inner cylindrical member at a distance so as to form a flow path for the first fluid;

a cylindrical connecting member configured to connect an upstream end portion of the first outer cylindrical member to an upstream side of the upstream cylindrical member so as to form the flow path for the first fluid; and

a downstream cylindrical member having a portion, the portion being connected to a downstream end portion of the first outer cylindrical member and being arranged on a radially outer side of the inner cylindrical member at a distance so as to form the flow path for the first fluid,

wherein the heat exchanger further comprises a valve mechanism having an on-off valve located on a downstream end portion side of the inner cylindrical member, and

wherein the valve mechanism is rotatably supported by a bearing arranged on a radially outer side of the downstream cylindrical member, and the on-off valve is fixed to a shaft arranged so as to penetrate the downstream cylindrical member and the inner cylindrical member.

Also, the present invention relates to a heat exchanger, comprising:

a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;

a first outer cylindrical member fitted to a surface of the outer peripheral wall of the pillar shaped honeycomb structure;

an inner cylindrical member fitted to a surface of the inner peripheral wall of the pillar shaped honeycomb structure;

an upstream cylindrical member having a portion arranged on a radially inner side of the inner cylindrical member at a distance so as to form a flow path for the first fluid;

a cylindrical connecting member configured to connect an upstream end portion of the first outer cylindrical member to an upstream side of the upstream cylindrical member so as to form the flow path for the first fluid; and

a downstream cylindrical member having a portion, the portion being connected to a downstream end portion of the first outer cylindrical member and being arranged on a radially outer side of the inner cylindrical member at a distance so as to form the flow path for the first fluid,

wherein the heat exchanger comprises at least one of:

i) two seal members each arranged on an outer peripheral surface of the inner cylindrical member; and

ii) two seal portions each provided on an outer peripheral surface of the inner cylindrical member, and

wherein each of surfaces of the outer peripheral walls on the first end face side and the second end face side of the pillar shaped honeycomb structure is fitted via at least one of the two sealing members and the two sealing portions.

Thus, the present invention relates to a heat exchanger, comprising:

a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;

a first outer cylindrical member fitted to a surface of the outer peripheral wall of the pillar shaped honeycomb structure;

an inner cylindrical member fitted to a surface of the inner peripheral wall of the pillar shaped honeycomb structure;

an upstream cylindrical member having a portion arranged on a radially inner side of the inner cylindrical member at a distance so as to form a flow path for the first fluid;

a cylindrical connecting member configured to connect an upstream end portion of the first outer cylindrical member to an upstream side of the upstream cylindrical member so as to form the flow path for the first fluid; and

a downstream cylindrical member having a portion, the portion being connected to a downstream end portion of the first outer cylindrical member and being arranged on a radially outer side of the inner cylindrical member at a distance so as to form the flow path for the first fluid,

wherein the heat exchanger further comprises a valve mechanism having an on-off valve arranged on a downstream end portion side of the inner cylindrical member, and a stopper portion capable of coming in contact with a peripheral edge portion of the on-off valve is arranged on an inner peripheral surface of the inner cylindrical member.

### BRIEF DESCRIPTION OF THE DRAWINGS

FIG. 1 is a cross-sectional view of a heat exchanger according to Embodiment 1 of the present invention, which is parallel to a flow direction of a first fluid;

FIG. 2 is a cross-sectional view taken along the line a-a′ in the heat exchanger of FIG. 1;

FIG. 3 is a cross-sectional view of a heat exchanger according to Embodiment 2 according to the present invention, which is parallel to a flow direction of a first fluid;

FIG. 4 is a cross-sectional view taken along the line b-b′ in the heat exchanger of FIG. 3;

FIG. 5 is a cross-sectional view of another heat exchanger according to Embodiment 2 of the present invention, which is parallel to a flow direction of a first fluid;

FIG. 6 is a partially enlarged cross-sectional view for explaining a structure in which a seal member is provided between a honeycomb structure and a seal portion of an inner cylindrical member;

FIG. 7 is a partially enlarged cross-sectional view of a heat exchanger according to Embodiment 3 of the present invention around an on-off valve, which is parallel to a flow direction of a first fluid; and

FIGS. 8(A)-8(H) are views for explaining an impregnating and firing method for metal Si.

### DETAILED DESCRIPTION OF THE INVENTION

As a result of studies, the present inventors have found that the heat exchanger of Patent Literature 2 cannot have sufficient heat recovery performance during promotion of heat recovery, and there is still room for improvement of its structure.

The present invention has been made to solve the above problems. An object of the present invention is to provide a heat exchanger having improved heat recovery performance during promotion of heat recovery.

As results of intensive studies of a structure of a heat exchanger, the present inventors have found that a heat exchanger having a specific structure can solve the above problems, and have completed the present invention.

According to the present invention, it is possible to provide a heat exchanger having improved heat recovery performance during promotion of heat recovery.

Hereinafter, embodiments of the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

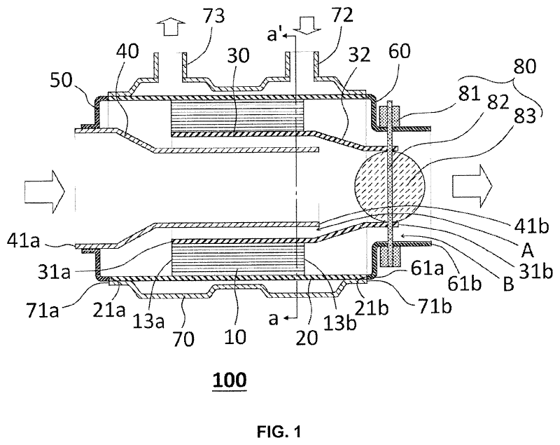

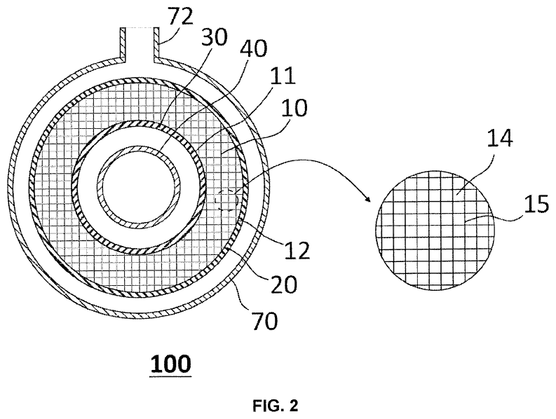

FIG. 1 is a cross-sectional view of a heat exchanger according to Embodiment 1 of the present invention, which is parallel to a flow direction of a first fluid. Further, FIG. 2 is a cross-sectional view taken along the line a-a′ in the heat exchanger of FIG. 1.

As shown in FIGS. 1 and 2, a heat exchanger 100 according to Embodiment 1 of the present invention includes: a hollow pillar shaped honeycomb structure 10 (which may, hereinafter, be abbreviated as a “pillar shaped honeycomb structure”); a first outer cylindrical member 20; an inner cylindrical member 30; an upstream cylindrical member 40; a cylindrical connecting member 50; a downstream cylindrical member 60; and a valve mechanism 80. Also, the heat exchanger 100 according to Embodiment 1 of the present invention may further include a second outer cylindrical member 70.

### <Hollow Pillar Shaped Honeycomb Structure 10>

The hollow pillar shaped honeycomb structure 10 includes an inner peripheral wall 11, an outer peripheral wall 12, and a partition wall 15 which is disposed between the inner peripheral wall 11 and the outer peripheral wall 12, and which defines a plurality of cells 14 extending from a first end face 13a to a second end face 13b to form flow paths for a first fluid.

As used herein, the “hollow pillar shaped honeycomb structure 10” refers to a pillar shaped honeycomb structure 10 having a hollow region at a central portion in a cross section of the hollow pillar shaped honeycomb structure 10, which is perpendicular to a flow direction of the first fluid.

A shape (outer shape) of the hollow pillar shaped honeycomb structure 10 is not particularly limited, but it may be, for example, a circular pillar shape, an elliptical pillar shape, a quadrangular pillar shape, or other polygonal pillar shape.

Also, a shape of the hollow region in the hollow pillar shaped honeycomb structure 10 is not particularly limited, but it may be, for example, a circular pillar shape, an elliptical pillar shape, a quadrangular pillar shape, or other polygonal pillar shape.

It should be note that the shape of the hollow pillar shaped honeycomb structure 10 and the shape of the hollow region may be the same as or different from each other. However, they are preferably the same as each other, in terms of resistance to external impact, thermal stress, and the like.

Each cell 14 may have any shape, including, but not particularly limited to, circular, elliptical, triangular, quadrangular, hexagonal and other polygonal shapes in a cross section in a direction perpendicular to a flow path direction of the first fluid. Also, the cells 14 are radially provided in a cross section in a direction perpendicular to the flow path direction of the first fluid. Such a structure can allow heat of the first fluid flowing through the cells 14 to be efficiently transmitted to the outside of the hollow pillar shaped honeycomb structure 10.

A thickness of the partition wall 15 may preferably be from 0.1 to 1 mm, and more preferably from 0.2 to 0.6 mm, although not particularly limited thereto. The thickness of the partition wall 15 of 0.1 mm or more can provide the hollow pillar shaped honeycomb structure 10 with a sufficient mechanical strength. Further, the thickness of the partition wall 5 of 1.0 mm or less can suppress problems that the pressure loss is increased due to a decrease in an opening area and the heat recovery efficiency is decreased due to a decrease in a contact area with the first fluid.

Each of the inner peripheral wall 11 and the outer peripheral wall 12 preferably has a thickness larger than that of the partition wall 15, although not particularly limited thereto. Such a structure can lead to increased strength of the inner peripheral wall 11 and the outer peripheral wall 12 which would otherwise tend to generate breakage (e.g., cracking, chinking, and the like) by external impact, thermal stress due to a temperature difference between the first fluid and the second fluid, and the like.

In addition, the thicknesses of the inner peripheral wall 11 and the outer peripheral wall 12 are not particularly limited, and they may be adjusted as needed according to applications and the like. For example, the thickness of each of the inner peripheral wall 11 and the outer peripheral wall 12 is preferably from 0.3 mm to 10 mm, and more preferably from 0.5 mm to 5 mm, and even more preferably from 1 mm to 3 mm, when using the heat exchange 100 for general heat exchange applications. Moreover, when using the heat exchanger 100 for heat storage applications, the thickness of the outer peripheral wall 12 is preferably 10 mm or more, in order to increase a heat capacity of the outer peripheral wall 12.

The partition wall 15, the inner peripheral wall 11 and the outer peripheral wall 12 preferably contain ceramics as a main component. The phrase “contain ceramics as a main component” means that a ratio of a mass of ceramics to the mass of the total component is 50% by mass or more.

Each of the partition wall 15, the inner peripheral wall 11 and the outer peripheral wall 12 preferably has a porosity of 10% or less, and more preferably 5% or less, and even more preferably 3% or less, although not particularly limited thereto. Further, the porosity of the partition wall 15, the inner peripheral wall 11 and the outer peripheral wall 12 may be 0%. The porosity of the partition wall 15, the inner peripheral wall 11 and the outer peripheral wall 12 of 10% or less can lead to improvement of thermal conductivity.

The partition wall 15, the inner peripheral wall 11 and the outer peripheral wall 12 preferably contain SiC (silicon carbide) having high thermal conductivity as a main component. Examples of such a material includes Si-impregnated SiC, (Si+Al) impregnated SiC, a metal composite SiC, recrystallized SiC, Si₃N₄, SiC, and the like. Among them, Si-impregnated SiC and (Si+Al) impregnated SiC are preferably used because they can allow production at lower cost and have high thermal conductivity.

A cell density (that is, the number of cells 14 per unit area) in the cross section of the hollow pillar shaped honeycomb structure 10 perpendicular to the flow path direction of the first fluid is preferably in a range of from 4 to 320 cells/cm², although not particularly limited thereto. The cell density of 4 cells/cm² or more can sufficiently ensure the strength of the partition walls 15, hence the strength of the hollow pillar shaped honeycomb structure 10 itself and effective GSA (geometrical surface area). Further, the cell density of 320 cells/cm² or less can allow prevention of an increase in a pressure loss when the first fluid flows.

The hollow pillar shaped honeycomb structure 10 preferably has an isostatic strength of more than 100 MPa, and more preferably 150 MPa or more, and still more preferably 200 MPa or more, although not particularly limited thereto. The isostatic strength of the hollow pillar shaped honeycomb structure 10 of 100 MPa or more can lead to the hollow pillar shaped honeycomb structure 10 having improved durability. The isostatic strength of the hollow pillar shaped honeycomb structure 10 can be measured according to the method for measuring isostatic strength as defied in the JASO standard M505-87 which is a motor vehicle standard issued by Society of Automotive Engineers of Japan, Inc.

A diameter (an outer diameter) of the outer peripheral wall 12 in the cross section in direction perpendicular to the flow path direction of the first fluid may preferably be from 20 to 200 mm, and more preferably from 30 to 100 mm, although not particularly limited thereto. Such a diameter can allow improvement of heat recovery efficiency. When the shape of the outer peripheral wall 12 is not circular, the diameter of the largest inscribed circle that is inscribed in the cross-sectional shape of the outer peripheral wall 12 is defined as the diameter of the outer peripheral wall 12.

Further, a diameter of the inner peripheral wall 11 in the cross section in the direction perpendicular to the flow path direction of the first fluid may preferably be from 1 to 50 mm, and more preferably from 2 to 30 mm, although not particularly limited thereto. When the cross-sectional shape of the inner peripheral wall 11 is not circular, the diameter of the largest inscribed circle that is inscribed in the cross-sectional shape of the inner peripheral wall 11 is defined as the diameter of the inner peripheral wall 11.

The hollow pillar shaped honeycomb structure 10 preferably has a thermal conductivity of 50 W/(m·K) or more at 25° C., and more preferably from 100 to 300 W/(m·K), and even more preferably from 120 to 300 W/(m K), although not particularly limited thereto. The thermal conductivity of the hollow pillar shaped honeycomb structure 10 in such a range can lead to an improved thermal conductivity and can allow the heat inside the hollow pillar shaped honeycomb structure 10 to be efficiently transmitted to the outside. It should be noted that the value of thermal conductivity is a value measured according to the laser flash method (JIS R 1611-1997).

In the case where an exhaust gas as the first fluid flows through the cells 14 in the hollow pillar shaped honeycomb structure 10, a catalyst may be supported on the partition wall 15 of the pillar shaped honeycomb structure 10. The supporting of the catalyst on the partition wall 15 can allow CO, NOx, HC and the like in the exhaust gas to be converted into harmless substances through catalytic reaction, and can also allow reaction heat generated during the catalytic reaction to be utilized for heat exchange. Preferable catalysts include those containing at least one element selected from the group consisting of noble metals (platinum, rhodium, palladium, ruthenium, indium, silver and gold), aluminum, nickel, zirconium, titanium, cerium, cobalt, manganese, zinc, copper, tin, iron, niobium, magnesium, lanthanum, samarium, bismuth, and barium. Any of the above-listed elements may be contained as a metal simple substance, a metal oxide, or other metal compound.

A supported amount of the catalyst (catalyst metal+support) may preferably be from 10 to 400 g/L, although not particularly limited thereto. Further, when using the catalyst containing the noble metal(s), the supported amount may preferably be from 0.1 to 5 g/L, although not particularly limited thereto. The supported amount of the catalyst (catalyst metal+support) of 10 g/L or more can easily achieve catalysis. Also, the supported amount of the catalyst (catalyst metal+support) of 400 g/L or less can allow suppression of both an increase in a pressure loss and an increase in a manufacturing cost. The support refers to a carrier on which a catalyst metal is supported. Examples of the supports include those containing at least one selected from the group consisting of alumina, ceria and zirconia.

### <First Outer Cylindrical Member 20>

The first outer cylindrical member 20 is fitted to a surface (outer peripheral surface) of the outer peripheral wall 12 of the pillar shaped honeycomb structure 10. The fitting may be either directly or indirectly performed, but it may preferably be directly performed in terms of heat recovery efficiency.

The first outer cylindrical member 20 is a cylindrical member having an upstream end portion 21a and a downstream end portion 21b.

It is preferable that an axial direction of the first outer cylindrical member 20 coincides with that of the pillar shaped honeycomb structure 10, and a central axis of the first outer cylindrical member 20 coincides with that of the pillar shaped honeycomb structure 10. Also, a central position of the first outer cylindrical member 20 in an axial direction may coincide with that of the pillar shaped honeycomb structure 10 in the axial direction. Further, diameters (an outer diameter and an inner diameter) of the first outer cylindrical member 20 may be uniform in the axial direction, but the diameter of at least a part (for example, both ends in the axial direction or the like) of the first outer cylinder may be increased or decreased.

Non-limiting examples of the first outer cylindrical member 20 that can be used herein include a cylindrical member fitted to the surface of the outer peripheral wall 12 of the pillar shaped honeycomb structure 10 to cover circumferentially the outer peripheral wall 12 of the pillar shaped honeycomb structure 10.

As used herein, the “fitted” means that the pillar shaped honeycomb structure 10 and the first outer cylindrical member 20 are fixed in a state of being suited to each other. Therefore, the fitting of the pillar shaped honeycomb structure 10 and the first outer cylindrical member 20 encompasses cases where the pillar shaped honeycomb structure 10 and the first outer cylindrical member 20 are fixed to each other by a fixing method based on fitting such as clearance fitting, interference fitting and shrinkage fitting, as well as by brazing, welding, diffusion bonding, and the like.

The first outer cylindrical member 20 may preferably have an inner surface shape corresponding to the surface of the outer peripheral wall 12 of the pillar shaped honeycomb structure 10. Since the inner surface of the first outer cylindrical member 20 is in direct contact with the outer peripheral wall 12 of the pillar shaped honeycomb structure 10, the thermal conductivity is improved and the heat in the pillar shaped honeycomb structure 10 can be efficiently transferred to the first outer cylindrical member 20.

In terms of improvement of the heat recovery efficiency, a higher ratio of an area of a portion circumferentially covered with the first outer cylindrical member 20 in the outer peripheral wall 12 of the pillar shaped honeycomb structure 10 to the total area of the outer peripheral wall 12 of the pillar shaped honeycomb structure 10 is preferable. Specifically, the area ratio is preferably 80% or more, and more preferably 90% or more, and even more preferably 100% (that is, the entire outer peripheral wall 12 of the pillar shaped honeycomb structure 10 is circumferentially covered with the first outer cylindrical member 20).

It should be noted that the term “the surface of the outer peripheral wall 12” as used herein refers to a surface of the pillar shaped honeycomb structure 10, which is parallel to the flow path direction of the first fluid, and does not include surfaces (the first end face 13a and the second end face 13b) of the pillar shaped honeycomb structure 10, which are perpendicular to the flow path direction of the first fluid.

The first outer cylindrical member 20 is preferably made of a metal in terms of manufacturability, although not particularly limited thereto. Further, the metallic first outer cylindrical member 20 is also preferable in that it can be easily welded to a second outer cylindrical member 70 or the like, which will be described below. Examples of the material of the first outer cylindrical member 20 that can be used herein include stainless steel, titanium alloys, copper alloys, aluminum alloys, brass and the like. Among them, the stainless steel is preferable because it has high durability and reliability and is inexpensive.

The first outer cylindrical member 20 preferably has a thickness of 0.1 mm or more, and more preferably 0.3 mm or more, and still more preferably 0.5 mm or more, although not particularly limited thereto. The thickness of the first outer cylindrical member 20 of 0.1 mm or more can ensure durability and reliability. The thickness of the first outer cylindrical member 20 is preferably 10 mm or less, and more preferably 5 mm or less, and still more preferably 3 mm or less. The thickness of the first outer cylindrical member 20 of 10 mm or less can reduce thermal resistance and improve thermal conductivity.

### <Inner Cylindrical Member 30>

The inner cylindrical member 30 is fitted to a surface (an inner peripheral surface) of the inner peripheral wall 11 of the pillar shaped honeycomb structure 10. The fitting may be either direct or indirect.

The inner cylindrical member 30 is a cylindrical member having an upstream end portion 31a and a downstream end portion 31b.

The inner cylindrical member 30 preferably has a tapered portion 32 whose diameter is reduced from the position of the second end face 13b of the pillar shaped honeycomb structure 10 to the downstream end portion 31b. The providing of such a tapered portion 32 can reduce a difference between the inner diameter of the downstream end portion 31b of the inner cylindrical member 30 and the inner diameter of the downstream end portion 41b of the upstream cylindrical member 40.

In this case, when heat recovery is suppressed (when the on-off valve 83 is opened), it can achieve the equivalent flow rate of the first fluid in the vicinity of the downstream end portion 41b of the upstream cylindrical member 40 (in the vicinity of the heat recovery path inlet A when promoting the heat recovery) to that of the first fluid in the vicinity of the downstream end portion 31b of the inner cylindrical member 30 (in the vicinity of the heat recovery path outlet B when promoting the heat recovery), thus decreasing a difference between pressures in the vicinity of the downstream end portion 41b of the upstream cylindrical member 40 and in the vicinity of the downstream end portion 31b of the inner cylindrical member 30. As a result, the backward flow phenomenon of the first fluid flowing from the heat recovery path outlet B to the heat recovery path inlet A can be suppressed, so that the heat insulation performance can be improved.

The tapered portion 32 has an inclination angle of the inner cylindrical member 30 relative to the axial direction of, preferably 45° or less, and more preferably 42° or less, and still more preferably 40° or less. The controlling of the inclination angle to such an angle can suppress the flow of the first fluid passing between the inner cylindrical member 30 and the upstream cylindrical member 40 to enter the pillar shaped honeycomb structure 10, when heat recovery is suppressed (when the on-off valve 83 is opened), so that the heat insulation performance can be improved.

In addition, the lower limit of the inclination angle of the tapered portion 32 is not particularly limited, but it may generally be 10°, and preferably 15°, in terms of provide the compact heat exchanger 100.

It is preferable that the upstream end portion 31a of the inner cylindrical member 30 is arranged at substantially the same position as the first end face 13a of the pillar shaped honeycomb structure 10. Such a structure can shorten the flow path for the first fluid passing between the inner cylindrical member 30 and the upstream cylindrical member 40 to enter the pillar shaped honeycomb structure 10, when heat recovery is promoted (when the on-off valve 83 is closed), so that the heat recovery performance can be improved.

As used herein, the “substantially the same position as the first end face 13a of the pillar shaped honeycomb structure 10” is a concept including not only the same position as the first end face 13a but also a position displaced by about ±10 mm from the first end face 13a of the pillar shaped honeycomb structure 10 in the axial direction of the pillar shaped honeycomb structure 10.

It is preferable that an axial direction of the inner cylindrical member 30 coincides with that of the pillar shaped honeycomb structure 10, and a central axis of the inner cylindrical member 30 coincides with that of the pillar shaped honeycomb structure 10. Further, it is also preferable that an axial center position of the inner cylindrical member 30 coincides with that of the pillar shaped honeycomb structure 10.

Non-limiting examples of the inner cylindrical member 30 that can be used herein includes a cylindrical member in which a part of the outer peripheral surface of the inner cylindrical member 30 is in contact with the surface of the inner peripheral wall 11 of the pillar shaped honeycomb structure 10.

Here, a part of the outer peripheral surface of the inner cylindrical member 30 and the surface of the inner peripheral wall 11 of the pillar shaped honeycomb structure 10 may be in direct contact with each other or indirect contact with each other via another member (e.g., a heat insulating mat).

The part of the outer peripheral surface of the inner cylindrical member 30 and the surface of the inner peripheral wall 11 of the pillar shaped honeycomb structure 10 are fixed to each other in a state where they are fitted to each other. A fixing method includes, but not limited to, the same method as that of the first outer cylindrical member 20 as described above.

A material of the inner cylindrical member 30 includes, but not limited to, the same materials as those of the first outer cylindrical member 20 as described above.

A thickness of the inner cylindrical member 30 includes, but not limited to, the same thickness as that of the first outer cylindrical member 20 as described above.

### <Upstream Cylindrical Member 40>

The upstream cylindrical member 40 has a portion arranged on a radially inner side of the inner cylindrical member 30 at a distance so as to form a flow path for the first fluid.

The upstream cylindrical member 40 is a cylindrical member having an upstream end portion 41a and a downstream end portion 41b.

It is preferable that an axial direction of the upstream cylindrical member 40 coincides with that of the pillar shaped honeycomb structure 10, and a central axis of the upstream cylindrical member 40 coincides with that of the pillar shaped honeycomb structure 10.

In the upstream cylindrical member 40, the downstream end portion 41b preferably extends on a downstream side of the position of the second end face 13b of the pillar shaped honeycomb structure 10. Such a structure can shorten the distance between the vicinity of the downstream end portion 41b of the upstream cylindrical member 40 (the vicinity of the heat recovery path inlet A when promoting heat recovery) and the vicinity of the downstream end portion 31b of the inner cylindrical member 30 (the vicinity of the heat recovery path outlet B when promoting heat recovery), so that the pressure difference between both is decreased when heat recovery is suppressed (when the on-off valve 83 is opened). As a result, the backward flow phenomenon of the first fluid flowing from the heat recovery path outlet B to the heat recovery path inlet A can be suppressed, so that the heat insulation performance can be improved.

The structure of the upstream cylindrical member 40 on the upstream end portion 41a side is not particularly limited, but it may be adjusted as needed, depending on the shape of other component (e.g., piping) to which the upstream end portion 41a of the upstream cylindrical member 40 is connected. For example, when the diameter of the other component is larger than that of the upstream end portion 41a, the diameter of the upstream end portion 41a may be increased as shown in FIG. 1.

A method of fixing the upstream cylindrical member 40 is not particularly limited, but the upstream cylindrical member 40 may be fixed to the first cylindrical member 20 or the like via a cylindrical connecting member 50 described below. The fixing method includes, but not limited to, the same method as that of the first outer cylindrical member 20 as described above.

A material of the upstream cylindrical member 40 includes, but not limited to, the same materials as those of the first outer cylindrical member 20 as listed above.

A thickness of the upstream cylindrical member 40 includes, but not limited to, the same thickness as that of the first outer cylindrical member 20 as described above.

### <Cylindrical Connecting Member 50>

The cylindrical connecting member 50 is a cylindrical member that connects the upstream end portion 21a of the first outer cylindrical member 20 to the upstream side of the upstream cylindrical member 40 so as to form the flow path for the first fluid. The connection may be direct or indirect. In the case of indirect connection, for example, an upstream end portion 71a of a second outer cylindrical member 70, which will be described later, or the like may be arranged between the upstream end portion 21a of the first outer cylindrical member 20 and the upstream side of the upstream cylindrical member 40.

It is preferable that an axial direction of the cylindrical connecting member 50 coincides with that of the pillar shaped honeycomb structure 10, and a central axis of the cylindrical connecting member 50 coincides with that of the pillar shaped honeycomb structure 10.

The shape of the cylindrical connecting member 50 is not particularly limited, but it may have a curved structure. Such a structure can provide smooth flowing of the first fluid entering through the heat recovery path inlet A to flows to the pillar shaped honeycomb structure 10 during proportion of heat recovery (when the on-off valve 83 is opened), so that the pressure loss can be reduced.

A material of the cylindrical connecting member 50 includes, but not limited to, the same materials as those of the first outer cylindrical member 20 as listed above.

A thickness of the cylindrical connecting member 50 includes, but not limited to, the same thickness as that of the first outer cylindrical member 20 as described above.

### <Downstream Cylindrical Member 60>

The downstream cylindrical member 60 has a portion which is connected to the downstream end portion 21b of the first outer cylindrical member 20 and which is arranged on a radially outer side of the inner cylindrical member 30 at a distance so as to form the flow phat for the first fluid. The connection may be direct or indirect. In the case of indirect connection, for example, a downstream end portion 71b of a second outer cylindrical member 70 which will be described below, or the like, may be arranged between the downstream cylindrical member 60 and the downstream end portion 21b of the first outer cylindrical member 20.

The downstream cylindrical member 60 is a cylindrical member having an upstream end portion 61a and a downstream end portion 61b.

It is preferable that an axial direction of the downstream cylindrical member 60 coincides with that of the pillar shaped honeycomb structure 10, and a central axis of the downstream cylindrical member 60 coincides with that of the pillar shaped honeycomb structure 10.

Diameters (outer diameter and inner diameter) of the downstream cylindrical member 60 may be uniform in the axial direction, but at least a part of the diameters may be decreased or increased.

A material of the downstream cylindrical member 60 includes, but not limited to, the same materials as those of the first outer cylindrical member 20 as listed above.

A thickness of the downstream cylindrical member 60 includes, but not limited to, the same thickness as that of the first outer cylindrical member 20 as described above.

### <Second Outer Cylindrical Member 70>

The second outer cylindrical member 70 is arranged on a radially outer side of the first outer cylindrical member 20 at a distance so as to form a flow path for a second fluid.

The second outer cylindrical member 70 is a cylindrical member having an upstream end portion 71a and a downstream end portion 71b.

It is preferable that an axial direction of the outer cylindrical member 70 coincides with that of the pillar shaped honeycomb structure 10, and a central axis of the second outer cylindrical member 70 coincides with that of the pillar shaped honeycomb structure 10.

The upstream end portion 71a of the second outer cylindrical member 70 preferably extends beyond the position of the first end face 13a of the pillar shaped honeycomb structure 10 to the upstream side. Such a structure can allow a heat recovery efficiency to be improved.

The second outer cylindrical member 70 is preferably connected to both a feed pipe 72 for feeding the second fluid to a region between the second outer cylindrical member 70 and the first outer cylindrical member 20, and a discharge pipe 73 for discharging the second fluid from a region between the second outer cylindrical member 70 and the first outer cylindrical member 20. The feed pipe 72 and the discharge pipe 73 are preferably provided at positions corresponding to both axial ends of the pillar shaped honeycomb structure 10, respectively.

The feed pipe 72 and the discharge pipe 73 may extend in the same direction, or may extend in different directions.

The second outer cylindrical member 70 is preferably arranged such that inner peripheral surfaces of the upstream end portion 71a and the downstream end portion 71b are in direct or indirect contact with the outer peripheral surface of the first outer cylindrical member 20.

A method of fixing the inner peripheral surfaces of the upstream end portion 71a and the downstream end portion 71b of the second outer cylindrical member 70 to the outer peripheral surface of the first outer cylindrical member 20 that can be used herein includes, but not limited to, fitting such as clearance fitting, interference fitting and shrinkage fitting, as well as brazing, welding, diffusion bonding, and the like.

Diameters (outer diameter and inner diameter) of the second outer cylindrical member 70 may be uniform in the axial direction, but the diameter of at least a part (for example, a central portion in the axial direction, both ends in the axial direction, or the like) of the second outer cylindrical member 70 may be decreased or increased. For example, by decreasing the diameter of the central portion in the axial direction of the second outer cylindrical member 70, the second fluid can spread throughout the outer peripheral direction of the first outer cylindrical member 20 in the second outer cylindrical member 70 on the feed pipe 72 and discharge pipe 73 sides. Therefore, an amount of the second fluid that does not contribute to the heat exchange at the central portion in the axial direction is reduced, so that the heat exchange efficiency can be improved.

A material of the second outer cylindrical member 70 includes, but not limited to, the same materials as those of the first outer cylindrical member 20 as listed above.

A thickness of the second outer cylindrical member 70 includes, but not limited to, the same thickness as that of the first outer cylindrical member 20 as described above.

### <Valve Mechanism 80>

The valve mechanism 80 has an on-off valve 83 arranged on the downstream end portion 31b side of the inner cylindrical member 30. The on-off valve 83 is rotatably supported by a bearing 81 arranged on a radially outer side of the downstream cylindrical member 60, and is fixed to a shaft 82 arranged so as to penetrate the downstream cylindrical member 60 and the inner cylindrical member 30.

In the conventional heat exchanger, the bearing 81 is arranged in a space between the radially outer side of the inner cylindrical member 30 and the downstream cylindrical member 60. In this case, the bearing 81 is exposed to an exhaust gas at an elevated temperature, so that the bearing 81 is degraded and the on-off valve 83 cannot be stably opened and closed. In particular, if it is difficult to close the on-off valve 83 when promoting heat recovery, an amount of the first fluid flowing through the pillar shaped honeycomb structure 10 is reduced, so that the heat recovery performance is deteriorated. Further, if the bearing 81 is in the space, it may cause an increase in pressure loss. Further, in order to provide the bearing 81, it is necessary to increase the space between the radially outer side of the inner cylindrical member 30 and the downstream cylindrical member 60, so that the size and weight of the heat exchanger may be increased.

Therefore, the heat exchanger 100 according to Embodiment 1 of the present invention solves the above various problems by arranging the bearing 81 on the radially outer side of the downstream cylindrical member 60. More particularly, since the bearing 81 is not exposed to the exhaust gas at an elevated temperature, the bearing 81 is prevented from being degraded. As a result, the on-off valve 83 can be stably closed when heat recovery is promoted, and the heat recovery performance can be improved. Further, since the bearing 81 is not present in the flow path for the first fluid, the pressure loss can be reduced. Furthermore, since the bearing 81 is arranged on the radially outer side of the downstream cylindrical member 60, there is no need for ensuring a space for arranging the bearing 81 between the radially outer side of the inner cylindrical member 30 and the downstream cylindrical member 60, and the space can be reduced, so that the size and weight of the heat exchanger 100 can be decreased.

The valve mechanism 80 is not particularly limited as long as it has the above structure. Since the structure of the valve mechanism 80 itself is known in the art, the known valve mechanism can be applied to the heat exchanger 100 according to Embodiment 1 of the present invention. The shape of the on-off valve 83 may be appropriately selected depending on the shape of the inner cylindrical member 30 in which the on-off valve 83 is to be provided.

The valve mechanism 80 can drive (rotate) the shaft 82 by an actuator (not shown). The on-off valve 83 can be opened and closed by rotating the on-off valve 83 together with the shaft 82.

The on-off valve 83 is configured so that the flow of the first fluid inside the inner cylindrical member 30 can be controlled. More particularly, by closing the on-off valve 83 during promotion of heat recovery, the first fluid can be circulated from the heat recovery path inlet A to the pillar shaped honeycomb structure 10. Further, by opening the on-off valve 83 during suppression of heat recovery, the first fluid can be circulated from the downstream end portion 31b side of the inner cylindrical member 30 to the downstream cylindrical member 60 to discharge the first fluid to the outside of the heat exchanger 100.

### <First Fluid and Second Fluid>

The first fluid and the second fluid used in the heat exchanger 100 are not particularly limited, and various liquids and gases can be used. For example, when the heat exchanger 100 is mounted on a motor vehicle, an exhaust gas can be used as the first fluid, and water or antifreeze (LLC defined by JIS K2234: 2006) can be used as the second fluid. Further, the first fluid can be a fluid having a temperature higher than that of the second fluid.

### <Method for Producing Heat Exchanger 100>

The heat exchanger 100 can be produced in accordance with a method known in the art. For example, the heat exchanger 100 can be produced in accordance with the method as described below.

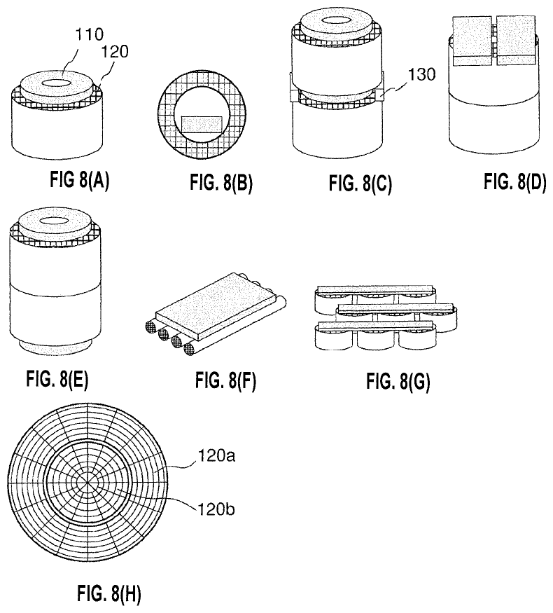

First, a green body containing ceramic powder is extruded into a desired shape to prepare a honeycomb formed body. At this time, the shape and density of the cells 14, and lengths and thicknesses of the partition wall 15, the inner peripheral wall 11 and the outer peripheral wall 12, and the like, can be controlled by selecting dies and jigs in appropriate forms. The material of the honeycomb formed body that can be used herein includes the ceramics as described above. For example, when producing a honeycomb formed body containing the Si-impregnated SiC composite as a main component, a binder and water or an organic solvent are added to a predetermined amount of SiC powder, and the resulting mixture is kneaded to form a green body, which can be then formed into a honeycomb formed body having a desired shape. The resulting honeycomb formed body can be then dried, and the honeycomb formed body can be impregnated with metal Si and fired under reduced pressure in an inert gas or vacuum to obtain a hollow pillar shaped honeycomb structure 10 having the cells 14 defined by the partition wall 15. The impregnating and firing of metal Si include, as shown in FIGS. 8(A) to 8(G), arranging a lump 110 containing the metal Si and a honeycomb formed body 120 such that they are contacted with each other, and firing them. The contacted point of the lump 110 containing the metal Si in the honeycomb formed body 120 may be the end face, the surface of the outer peripheral wall, or the surface of the inner peripheral wall. Further, when the impregnating and the firing are carried out while stacking a plurality of honeycomb formed bodies 120, as shown in FIG. 8(C), a support member 130 such as a support column may be provided between the two honeycomb formed bodies 120 to be stacked. Furthermore, as shown in FIGS. 8(D) and 8(E), the two honeycomb formed bodies 120 may be brought into contact with each other without providing the support member 130, and in this case, the honeycomb formed bodies 120 impregnated with the metal Si by the impregnating and firing may be joined together. Moreover, from the viewpoint of productivity of the honeycomb formed bodies 120 having various shapes, as shown in FIG. 8(H), a hollow honeycomb formed body 120a and a solid honeycomb formed body 120b arranged in the hollow region of the former may be arranged, and their formed bodies may be arranged so as to be in contact with the lump 110 containing the metal Si, and subjected to the impregnating and firing.

The hollow pillar shaped honeycomb structure 10 is then inserted into the first outer cylindrical member 20, and the first outer cylindrical member 20 is fitted to the surface of the outer peripheral wall 12 of the hollow pillar shaped honeycomb structure 10. Subsequently, the inner cylindrical member 30 is inserted into the hollow region of the hollow pillar shaped honeycomb structure 10 and the inner cylindrical member 30 is fitted to the surface of the inner peripheral wall 11 of the hollow pillar shaped honeycomb structure 10. The second outer cylindrical member 70 is then arranged on and fixed to the radially outer side of the first outer cylindrical member 20. The feed pipe 72 and the discharge pipe 73 may be previously fixed to the second outer cylindrical member 70, but they may be fixed to the second outer cylindrical member 70 at an appropriate stage. Next, the upstream cylindrical member 40 is arranged on the radially inner side of the inner cylindrical member 30, and the upstream end portion 21a of the first outer cylindrical member 20 and the upstream side of the upstream cylindrical member 40 are connected to each other via the cylindrical connecting member 50. The downstream cylindrical member 60 is then disposed at and connected to the downstream end portion 21b of the first outer cylindrical member 20. The valve mechanism 80 is then attached to the downstream end portion 31b side of the inner cylindrical member 30.

In addition, the arranging and fixing (fitting) orders of the respective members are not limited to the above orders, and they may be changed as needed within a range in which the members can be produced. As the fixing (fitting) method, the above method may be used.

### Embodiment 2

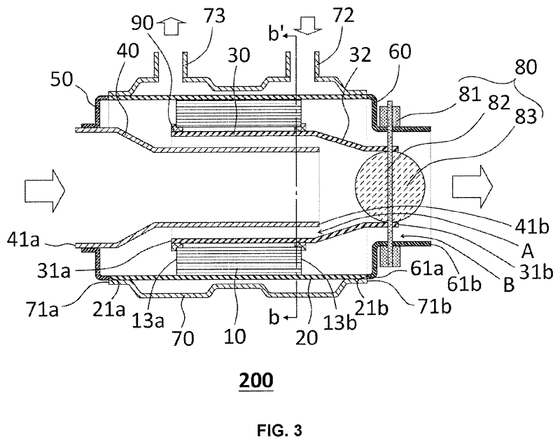

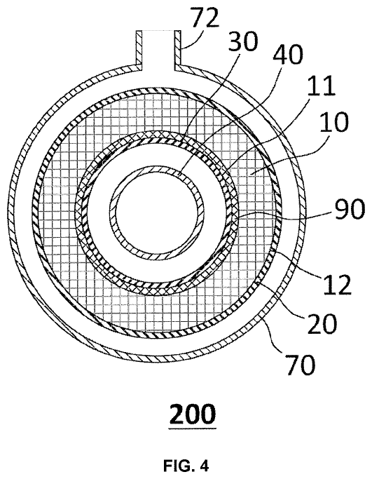

FIG. 3 is a cross-sectional view of a heat exchanger according to Embodiment 2 of the present invention, which is parallel to the flow direction of the first fluid. Further, FIG. 4 is a cross-sectional view taken along the line b-b′ in the heat exchanger of FIG. 3.

As shown in FIGS. 3 and 4, a heat exchanger 200 according to Embodiment of the present invention includes: a hollow pillar shaped honeycomb structure 10; a first outer cylindrical member 20; an inner cylindrical member 30; an upstream cylindrical member 40; a cylindrical connecting member 50; a downstream cylindrical member 60; and sealing members 90. Further, the heat exchanger 200 according to Embodiment 2 of the present invention may further include at least one of a valve mechanism 80 and a second outer cylindrical member 70.

The pillar shaped honeycomb structure 10, first outer cylindrical member 20, inner cylindrical member 30, upstream cylindrical member 40, cylindrical connecting member 50, downstream cylindrical member 60, valve mechanism 80 and second outer cylindrical member 70 in the heat exchanger 200 according to Embodiment 2 of the present invention may employ the same as those of the heat exchanger 100 according to Embodiment 1 of the present invention. However, the valve mechanism 80 in the heat exchanger 200 according to Embodiment 2 of the present invention may employ the same as that of the conventional heat exchanger (for example, a valve mechanism in which a bearing 81 is arranged in a space between the radially outer side of the inner cylindrical member 30 and the downstream cylindrical member 60). However, the use of the same as the heat exchanger 100 according to Embodiment 1 of the present invention can provide equivalent effects to those of the heat exchanger 100 according to Embodiment 1 of the present invention for the heat exchanger 200 according to Embodiment 2 of the present invention.

It should be noted that since the components having the same reference numerals as those appearing in the descriptions of the heat exchanger 100 according to Embodiment 1 of the present invention are the same as the components of the heat exchanger 200 according to Embodiment 2 of the present invention, the descriptions of those components will be omitted.

### <Sealing Member 90>

Two sealing members 90 are arranged on the outer peripheral surface of the inner cylindrical member 30. Then, each of the surfaces of the outer peripheral walls 12 on the first end face 13a side and the second end face 13b side of the pillar shaped honeycomb structures 10 is fitted to the inner cylindrical member 30 via each of the two sealing members 90.

In the conventional heat exchanger, the inner cylindrical member 30 is directly fitted to the surface of the inner peripheral wall 11 of the pillar shaped honeycomb structure 10, or is fitted via a heat insulating mat or the like. In the former case, a gap is generated between the inner cylindrical member 30 and the pillar shaped honeycomb structure 10 due to a difference between thermal expansions of the inner cylindrical member 30 and the pillar shaped honeycomb structure 10. As a result, the first fluid passes through that gap, and the pillar shaped honeycomb structure 10 cannot be held at a predetermined position, so that the heat recovery performance is deteriorated. Similarly, in the latter case, a gap is generated between the heat insulating mat and the pillar shaped honeycomb structure 10 due to a difference between thermal expansions of the heat insulating mat and the pillar shaped honeycomb structure 10. As a result, the first fluid passes through that gap, and the pillar shaped honeycomb structure 10 cannot be held at a predetermined position, so that the heat recovery performance is deteriorated. Further, in both cases, when the heat recovery is suppressed (when the on-off valve 83 is opened), the heat of the inner cylindrical member 30 is transferred directly to the pillar shaped honeycomb structure 10 or through the heat insulating mat, so that the heat insulation performance is also not sufficient.

Therefore, the heat exchanger 200 according to Embodiment 2 of the present invention solves the above various problems by fitting the pillar shaped honeycomb structure 10 and the inner cylindrical member 30 via the two sealing members 90. More particularly, the use of the sealing members 90 improves the adhesion between the pillar shaped honeycomb structure 10 and the inner cylindrical member 30, so that it is difficult to generate the gap between the inner cylindrical member 30 and the pillar shaped honeycomb structure 10. As a result, the passage of the first fluid through the gap can be suppressed, and the pillar shaped honeycomb structure 10 can be held at a predetermined position, so that the heat recovery performance can be improved. Further, the region between the two sealing members 90 is a space and the space has a heat insulating effect, so that the heat insulating performance can be improved.

The structure and material of each sealing member 90 are not particularly limited as long as they are sealable between the pillar shaped honeycomb structure 10 and the inner cylindrical member 30.

For example, each seal member 90 is preferably made of a metal. For example, stainless steel, titanium alloys, copper alloys, aluminum alloys, brass and the like can be used. Among them, the stainless steel is preferable because of its high durability and reliability and low cost.

Further, the sealing member 90 arranged on the first end face 13a side of the pillar shaped honeycomb structure 10 preferably has a structure where it is in contact with the surface of the inner peripheral wall 11 on the first end face 13a side of the pillar shaped honeycomb structure 10 and the outer peripheral surface on the first end face 13a side of the inner cylindrical member 30. Further, the sealing member 90 arranged on the second end face 13b side of the pillar shaped honeycomb structure 10 preferably has a structure where it is in contact with the surface of the inner peripheral wall 11 on the second end face 13b side of the pillar shaped honeycomb structure 10 and the outer peripheral wall on the second end face 13b side of the inner cylindrical member 30.

In the heat exchanger 200 according to Embodiment 2 of the present invention, the inner cylindrical member 30 may include two seal portions provided on the outer peripheral surface of the inner cylindrical member 30 instead of the seal member 90 or in addition to the seal member 90.

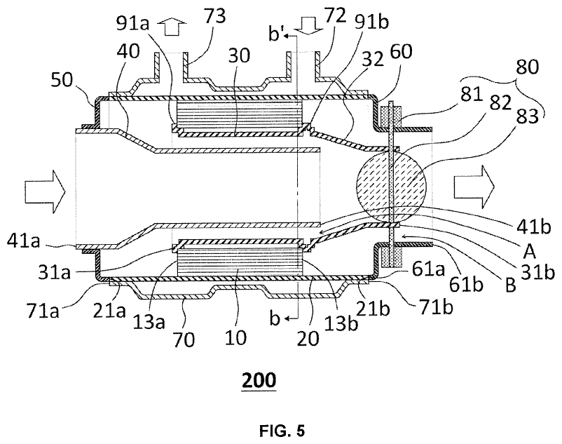

FIG. 5 is a cross-sectional view of a heat exchange in which the inner cylindrical member 30 is provided with seal portions 91a, 91b instead of the two sealing members 90, which is parallel to the flow direction of the first fluid. It should be noted that the cross-sectional view of the line b-b′ in the heat exchanger of FIG. 5 is omitted because it is the same as that of FIG. 4.

When arranging the sealing members 90, it is necessary to weld the sealing members 90 to the outer peripheral surface of the inner cylindrical member 30. However, it may be difficult to perform the welding. Therefore, by providing the sealing portions 91a, 91b on the outer peripheral surface of the inner cylindrical member 30, the welding can be eliminated. Further, when the sealing portions 91a, 91b are provided on the outer peripheral surface of the inner cylindrical member 30, the same effect as in the case where the two sealing members 90 are arranged on the outer peripheral surface of the inner cylindrical member 30 can be obtained.

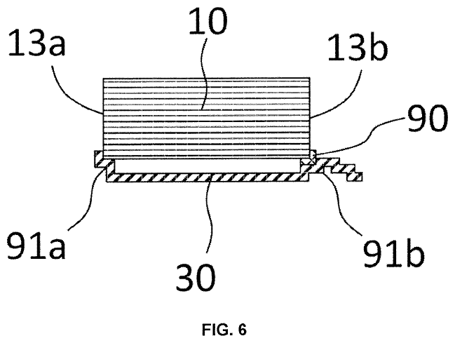

Further, the first end face 13a side and/or the second end face 13b side of the pillar shaped honeycomb structure 10 may be further provided with a sealing member(s) 90 made of a buffer material, in terms of further improvement of the sealing property, and prevention of breakage of the pillar shaped honeycomb structure 10 during formation (e.g., during buckling) of the sealing portions 91a, 91b. As an example, FIG. 6 shows a structure example in which the sealing members 90 are further provided on the second end face 13b side of the pillar shaped honeycomb structure 10. It should be noted that FIG. 6 is a partially enlarged cross-sectional view of the periphery of the pillar shaped honeycomb structure 10 and the inner cylindrical member 30, which is parallel to the flow direction of the first fluid. Examples of the sealing members 90 made of the buffer material include SUS mesh and the like.

The heat exchanger 200 according to Embodiment 2 of the present invention can be produced according to a method known in the art. For example, the heat exchanger 200 according to Embodiment 2 of the present invention can be produced according to the method for producing the heat exchanger 100 as described above.

The sealing member 90 may be arranged at a predetermined position of the hollow pillar shaped honeycomb structure 10 and then fitted by inserting the inner cylindrical member 30 into the hollow region of the hollow pillar shaped honeycomb structure 10.

If the sealing portions 91a, 91b are provided, they may be provided as follows. First, the sealing portion 91a is formed by bending the upstream end portion 31a of the inner cylindrical member 30. The inner cylindrical member 30 is then inserted into the hollow region of the pillar shaped honeycomb structure 10, and a load is then applied to a predetermined position of the inner cylindrical member 30 corresponding to the second end face 13b of the pillar shaped honeycomb structure 10 to buckle the predetermined region, thereby forming the sealing portion 91b. The portion of the inner cylindrical member 30 that forms the sealing portion 91b may be thinner than the other portions from the viewpoint of facilitating buckling. By thus forming the sealing portions 91a, 91b, the surfaces of the outer peripheral wall 12 on the first end face 13a side and the second end face 13b side of the pillar shaped honeycomb structure 10 can be fitted to the inner cylindrical member 30 via the sealing portions 91a, 91b, respectively.

### Embodiment 3

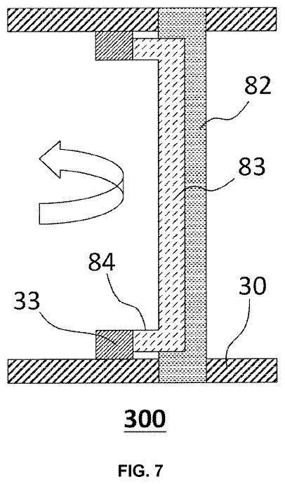

FIG. 7 is a partially enlarged cross-sectional view of a heat exchanger according to Embodiment 3 of the present invention around an on-off valve 83, which is parallel to the flow direction of the first fluid. It should be noted that FIG. 7 shows a state where the on-off valve 83 is closed.

A heat exchanger 300 according to Embodiment 3 of the present invention includes: a hollow pillar shaped honeycomb structure 10; a first outer cylindrical member 20; an inner cylindrical member 30; an upstream cylindrical member 40; a cylindrical connecting member 50; a downstream cylindrical member 60; and a valve mechanism 80. Further, the heat exchanger 300 according to Embodiment 3 of the present invention may further include at least one of a seal member 90 and a second outer cylindrical member 70.

The pillar shaped honeycomb structure 10, first outer cylindrical member 20, inner cylindrical member 30, upstream cylindrical member 40, cylindrical connecting member 50, downstream cylindrical member 60, valve mechanism 80 and second outer cylindrical member 70 in the heat exchanger 300 according to Embodiment 3 of the present invention may employ the same as those in the heat exchanger 100 according to Embodiment of the present invention. However, although the valve mechanism 80 in the heat exchanger 300 according to Embodiment 3 of the present invention may employ the same as that of the conventional heat exchanger (for example, a valve mechanism in which a bearing 81 is arranged in a space between the radially outer side of the inner cylindrical member 30 and the downstream cylindrical member 60), the use of the same valve mechanism as that of the heat exchanger 100 according to Embodiment 1 of the present invention can allow the heat exchanger 300 according to Embodiment 3 of the present invention to produce the equivalent effects to those of the heat exchanger 100 according to Embodiment 1 of the present invention. Further, the sealing member 90 in the heat exchanger 300 according to Embodiment 3 of the present invention may use the same as that of the heat exchanger 200 according to Embodiment 2 of the present invention. By providing the sealing member 90, the heat exchanger 300 according to Embodiment 3 of the present invention can produce the equivalent effects to those of the heat exchanger 200 according to Embodiment 2 of the present invention.

The components having the same reference numerals as those appearing in the descriptions of the heat exchangers 100, 200 according to Embodiments 1 and 2 of the present invention are the same as those of the heat exchanger 300 according to Embodiment 3 of the present invention. Therefore, detailed descriptions of those components will be omitted.

As shown in FIG. 7, in the heat exchanger 300 according to Embodiment 3 of the present invention, a stopper portion 33 capable of coming into contact with the peripheral edge portion of the on-off valve 83 of the valve mechanism 80 is arranged on the inner peripheral surface of the inner cylindrical member 30.

The conventional heat exchanger is configured such that the inner peripheral surface of the inner cylindrical member 30 and the on-off valve 83 are in contact with each other. Therefore, a gap tends to be generated between the inner cylindrical member 30 and the on-off valve 83, and the first fluid passes through the gap, resulting in deterioration of heat recovery performance.

Therefore, according to the heat exchanger 300 according to Embodiment 3 of the present invention, the above problem has been solved by arranging the stopper portion 33 capable of coming into contact with the peripheral edge portion of the on-off valve 83 on the inner peripheral surface of the inner cylindrical member 30, and bringing the stopper portion 33 and the peripheral edge portion of the on-off valve 83 into contact with each other. More particularly, the gap is difficult to be generated by bringing the stopper portion 33 into contact with the peripheral edge portion of the on-off valve 83, so that the heat recovery performance can be improved.

The material of the stopper portion 33 is not particularly limited, and the same material as that of the inner cylindrical member 30 can be used.

The on-off valve 83 preferably includes a convex portion 84 capable of coming into contact with the stopper portion 33 on the peripheral portion. Even if the gap is generated between the on-off valve 83 and the stopper portion 33, such a structure provides a longer gap flow path between the inner cylindrical member 30 and the on-off valve 83. As a result, the pressure loss in the gap flow path is increased, so that it will be difficult for the first fluid to pass through the gap flow path between the inner cylindrical member 30 and the on-off valve 83, and the heat recovery performance can be improved.

### DESCRIPTION OF REFERENCE NUMERALS

10 pillar shaped honeycomb structure
11 inner peripheral wall
12 outer peripheral wall
13a first end face
13b second end face
14 cell
15 partition wall
20 first outer cylindrical member
21a upstream end portion
21b downstream end portion
30 inner cylindrical member
31a upstream end portion
31b downstream end portion
32 tapered portion
33 stopper portion
40 upstream cylindrical member
41a upstream end portion
41b downstream end portion
50 cylindrical connecting member
60 downstream cylindrical member
61a upstream end portion
61b downstream end portion
70 second outer cylindrical member
71a upstream end portion
71b downstream end portion
72 feed pipe
73 discharge pipe
80 valve mechanism
81 bearing
82 shaft
83 on-off valve
90 sealing member
91a, 91b sealing portion
100, 200, 300 heat exchanger
110 lump containing metal Si
120 honeycomb formed body
120a hollow honeycomb formed body
120b solid honeycomb formed body
130 support member

1. A heat exchanger, comprising:
a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;
a first outer cylindrical member fitted to a surface of the outer peripheral wall of the pillar shaped honeycomb structure;
an inner cylindrical member fitted to a surface of the inner peripheral wall of the pillar shaped honeycomb structure;
an upstream cylindrical member having a portion arranged on a radially inner side of the inner cylindrical member at a distance so as to form a flow path for the first fluid;
a cylindrical connecting member configured to connect an upstream end portion of the first outer cylindrical member to an upstream side of the upstream cylindrical member so as to form the flow path for the first fluid; and
a downstream cylindrical member having a portion, the portion being connected to a downstream end portion of the first outer cylindrical member and being arranged on a radially outer side of the inner cylindrical member at a distance so as to form the flow path for the first fluid,
wherein the heat exchanger further comprises a valve mechanism having an on-off valve located on the downstream end portion side of the inner cylindrical member, and
wherein the valve mechanism is rotatably supported by a bearing arranged on a radially outer side of the downstream cylindrical member, and the on-off valve is fixed to a shaft arranged so as to penetrate the downstream cylindrical member and the inner cylindrical member.

2. The heat exchanger according to claim 1, wherein the heat exchanger comprises at least one of:
i) two seal members each arranged on an outer peripheral surface of the inner cylindrical member; and
ii) two seal portions each provided on an outer peripheral surface of the inner cylindrical member, and
wherein each of surfaces of the outer peripheral walls on the first end face side and the second end face side of the pillar shaped honeycomb structure is fitted via at least one of the two sealing members and the two sealing portions.

3. The heat exchanger according to claim 1, wherein a stopper portion capable of coming into contact with a peripheral edge portion of the on-off valve is arranged on an inner peripheral surface of the inner cylindrical member.

4. The heat exchanger according to claim 3, wherein a convex portion capable of coming into contact with the stopper portion is provided on the peripheral edge portion of the on-off valve.

5. A heat exchanger, comprising:
a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;
a first outer cylindrical member fitted to a surface of the outer peripheral wall of the pillar shaped honeycomb structure;
an inner cylindrical member fitted to a surface of the inner peripheral wall of the pillar shaped honeycomb structure;
an upstream cylindrical member having a portion arranged on a radially inner side of the inner cylindrical member at a distance so as to form a flow path for the first fluid;
a cylindrical connecting member configured to connect an upstream end portion of the first outer cylindrical member to an upstream side of the upstream cylindrical member so as to form the flow path for the first fluid; and
a downstream cylindrical member having a portion, the portion being connected to a downstream end portion of the first outer cylindrical member and being arranged on a radially outer side of the inner cylindrical member at a distance so as to form the flow path for the first fluid,
wherein the heat exchanger comprises at least one of:
i) two seal members each arranged on an outer peripheral surface of the inner cylindrical member; and
ii) two seal portions each provided on an outer peripheral surface of the inner cylindrical member, and
wherein each of surfaces of the outer peripheral walls on the first end face side and the second end face side of the pillar shaped honeycomb structure is fitted via at least one of the two sealing members and the two sealing portions.

6. The heat exchanger according to claim 5, wherein the heat exchanger further comprises a valve mechanism having an on-off valve arranged on the downstream end portion side of the inner cylindrical member, and a stopper portion capable of coming into contact with a peripheral edge portion of the on-off valve is arranged on an inner peripheral side of the inner cylinder member.

7. The heat exchanger according to claim 6, wherein a convex portion capable of coming into contact with the stopper portion is provided on the peripheral edge portion of the on-off valve.

8. A heat exchanger, comprising:
a hollow pillar shaped honeycomb structure having an inner peripheral wall, an outer peripheral wall and a partition wall disposed between the inner peripheral wall and the outer peripheral wall, the partition wall defining a plurality of cells, each of the cells extending from a first end face to a second end face to form a flow path for a first fluid;
a first outer cylindrical member fitted to a surface of the outer peripheral wall of the pillar shaped honeycomb structure;
an inner cylindrical member fitted to a surface of the inner peripheral wall of the pillar shaped honeycomb structure;
an upstream cylindrical member having a portion arranged on a radially inner side of the inner cylindrical member at a distance so as to form a flow path for the first fluid;
a cylindrical connecting member configured to connect an upstream end portion of the first outer cylindrical member to an upstream side of the upstream cylindrical member so as to form the flow path for the first fluid; and
a downstream cylindrical member having a portion, the portion being connected to a downstream end portion of the first outer cylindrical member and being arranged on a radially outer side of the inner cylindrical member at a distance so as to form the flow path for the first fluid,
wherein the heat exchanger further comprises a valve mechanism having an on-off valve arranged on a downstream end portion side of the inner cylindrical member, and a stopper portion capable of coming in contact with a peripheral edge portion of the on-off valve is arranged on an inner peripheral surface of the inner cylindrical member.

9. The heat exchanger according to claim 8, wherein a convex portion capable of coming into contact with the stopper portion is provided on the peripheral edge portion of the on-off valve.

10. The heat exchanger according to claim 1, wherein in the inner cylindrical member, the upstream end portion is arranged at substantially the same position as that of the first end face of the pillar shaped honeycomb structure.

11. The heat exchanger according to claim 1, further comprising a second outer cylindrical member arranged on a radially outer side of the first outer cylindrical member at a distance so as to form a flow path for a second fluid.

12. The heat exchanger according to claim 5, wherein in the inner cylindrical member, the upstream end portion is arranged at substantially the same position as that of the first end face of the pillar shaped honeycomb structure.

13. The heat exchanger according to claim 8, wherein in the inner cylindrical member, the upstream end portion is arranged at substantially the same position as that of the first end face of the pillar shaped honeycomb structure.

14. The heat exchanger according to claim 5, further comprising a second outer cylindrical member arranged on a radially outer side of the first outer cylindrical member at a distance so as to form a flow path for a second fluid.

15. The heat exchanger according to claim 8, further comprising a second outer cylindrical member arranged on a radially outer side of the first outer cylindrical member at a distance so as to form a flow path for a second fluid.
